(19) United States
(12) Patent Application Publication
(10) Pub. No.: US 2016/0150224 A1
(43) Pub. Date: May 26, 2016

(54) DEVICE AND METHOD FOR GENERATING SUPER MULTI-VIEWPOINT IMAGE

(71) Applicant: ELECTRONICS AND TELECOMMUNICATIONS RESEARCH INSTITUTE, Daejeon (KR)

(72) Inventors: Beom Ryeol LEE, Daejeon (KR); Jeung Chul PARK, Jeonju-si (KR); Hyung Jae SON, Daejeon (KR); Il Kwon JEONG, Daejeon (KR)

(21) Appl. No.: 14/939,725

(22) Filed: Nov. 12, 2015

(30) Foreign Application Priority Data
Nov. 25, 2014 (KR) 10-2014-0165188
Aug. 4, 2015 (KR) 10-2015-0110133

(51) Int. Cl. H04N 13/04

(52) U.S. Cl. CPC H04N 13/0429; H04N 13/0497

(57) ABSTRACT

A super multi-viewpoint image generating device includes a host system, a storage unit, first and second liquid crystal display (LCD) projection lamps, a synchronization unit, first and second LCD shutters, first and second projection objectives, and an image light combination unit, according to the present invention, a super multi-viewpoint image where interference between adjacent viewpoint images is removed by a viewing zone-based synchronized shutter timing may be generated, thereby providing an environment for generating a super multi-viewpoint image having a realistic level, establishing a method of generating a viewing zone-based super multi-viewpoint image, and displaying a super multi-viewpoint image.

### CROSS-REFERENCE TO RELATED APPLICATIONS

This application claims priority under 35 U.S.C. §119 to Korean Patent Application No. 10-2014-0165188, filed on Nov. 25, 2014, and Korean Patent Application No. 10-2015-0110133, filed on Aug. 4, 2015, the disclosure of which is incorporated herein by reference in its entirety.

### BACKGROUND OF THE INVENTION

1. Field of the Invention

The present invention relates to a super multi-viewpoint image generating device, and more particularly, to a super multi-viewpoint image generating device based on a projection method.

2. Description of the Related Art

Three-dimensional (3D) image display technology which is being commercialized at present respectively provides a left-eye image and a right-eye image having different viewpoints to a left eye and a right eye of a viewer by using a binocular disparity of two eyes, thereby enabling the viewer to feel a sense of three-dimensions.

However, since 3D image display technology of the related art provides a sense of three dimensions by using two viewpoint images including a left-eye image and a right-eye image, the 3D image display technology of the related art cannot appropriately reflect a change in a viewpoint caused by movement of a viewer. For this reason, there is a limitation in providing a natural 3D image.

To overcome the limitation, multi-viewpoint image display technology for providing a multi-viewpoint image has been proposed. The multi-viewpoint image display technology is technology that provides a 3D image having different viewpoints to a plurality of viewing zones.

Recently, super multi-viewpoint image display technology for enabling a viewer to view a 3D image with one eye has been developed.

The super multi-viewpoint image display technology is technology that provides a plurality of viewpoint images to one eye of a viewer, and generates a plurality of viewpoint images in a region which is smaller than a size of a pupillary of a viewer. Therefore, since a plurality of viewpoint images are projected onto a retina of a monocular pupillary, a viewer feels a sense of three dimensions with one eye and also feels a more natural sense of three dimensions.

In the super multi-viewpoint image display technology of the related art for acquiring a super multi-viewpoint image, a plurality of viewpoint images are acquired by using a plurality of cameras which are respectively disposed in a plurality of viewing zones, and an intermediate viewpoint image which is acquired from a viewing zone, where a camera is not disposed, between a camera and another camera is acquired by combining adjacent images, thereby acquiring a super multi-viewpoint image.

A device for displaying a super multi-viewpoint monocular image in a projection method controls a synchronization timing between a plurality of viewpoint images to generate the super multi-viewpoint monocular image.

A synchronization timing between a plurality of viewpoint images may be controlled by a shuttering method using one shutter (a single shutter).

When a synchronization timing between a plurality of viewpoint images is controlled by the shuttering method using one shutter, interference occurs between adjacent viewpoint images, causing a degradation in the display quality of a super multi-viewpoint image.

### SUMMARY

Accordingly, the present invention provides a device and method for generating a super multi-viewpoint image, which control a synchronization timing between a plurality of viewpoint images by using a single shutter, thereby preventing interference from occurring between adjacent viewpoint images.

In one general aspect, a super multi-viewpoint image generating device includes: a first shutter configured to receive a first viewpoint image to output first source light corresponding to the first viewpoint image according to a first shutter timing; a second shutter configured to receive a second viewpoint image adjacent to the first viewpoint image to output second source light corresponding to the second viewpoint image according to a second shutter timing which differs from the first shutter timing; a first projection objective configured to convert the first source light, output from the first shutter, into first image light according to the first shutter timing; a second projection objective configured to convert the second source light, output from the second shutter, into second image light according to the second shutter timing; and an image light combination unit configured to combine the first image light, output from the first projection objective, with the second image light output from the second projection objective to generate a super multi-viewpoint image.

In another general aspect, a super multi-viewpoint image generating method includes: selecting a first viewpoint image and a second viewpoint image with respect to a viewing zone of a viewer; generating first source light corresponding to the first viewpoint image and second source light corresponding to the second viewpoint image to respectively output the first source light and the second source light to a first shutter and a second shutter; outputting, by the first shutter, the first source light to a first projection objective according to a first shutter timing and outputting, by the second shutter, the second source light to a second projection objective according to a second shutter timing; converting, by the first projection objective, the first source light into first image light including image information and converting, by the second projection objective, the second source light into second image light including the image information; and combining, by an image light combination unit, the first image light with the second image light to generate a super multi-viewpoint image.

Other features and aspects will be apparent from the following detailed description, the drawings, and the claims.

### BRIEF DESCRIPTION OF THE DRAWINGS

FIG. 1 is a diagram illustrating a configuration of a super multi-viewpoint image generating device according to an embodiment of the present invention.

FIG. 2 is a diagram illustrating a configuration of a super multi-viewpoint image generating device according to another embodiment of the present invention.

FIGS. 3 to 5 are diagrams for describing operations of first and second liquid crystal display (LCD) shutters illustrated in FIG. 1.

FIG. 6 is a flowchart illustrating a super multi-viewpoint image generating method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

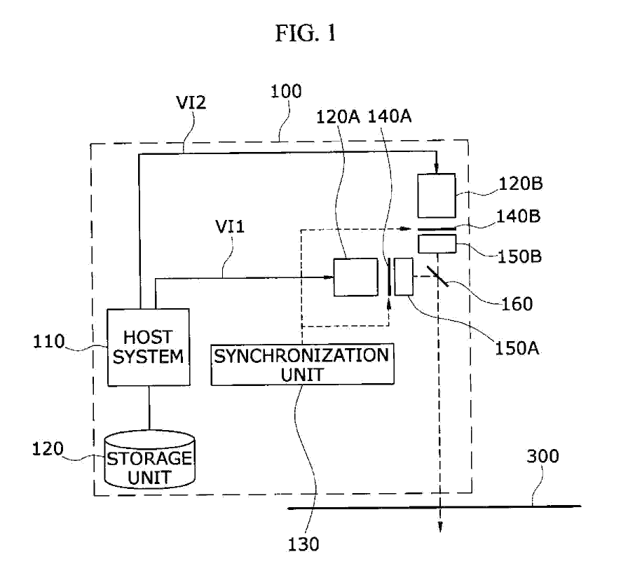

FIG. 1 is a diagram illustrating a configuration of a super multi-viewpoint image generating device 100 according to an embodiment of the present invention.

Referring to FIG. 1, the super multi-viewpoint image generating device 100 according to an embodiment of the present invention may generate a super multi-viewpoint image which is provided to one eye of a viewer.

To this end, the super multi-viewpoint image generating device 100 according to an embodiment of the present invention may include a host system 110, a storage unit 120, first and second liquid crystal display (LCD) projection lamps 120A and 120B, a synchronization unit 130, first and second LCD shutters 140A and 1408, first and second projection objectives 150A and 150B, and an image light combination unit 160.

The host system 110 may be an element that controls an overall operation of each of the elements of the super multi-viewpoint image generating device 100. Particularly, the host system 110 may select first and second viewpoint images VI1 and VI2, which are adjacent to each other with respect to a viewing zone of a viewer, from among a plurality of multi-viewpoint images stored in the storage unit 120 and may respectively load the selected first and second multi-viewpoint images VI1 and VI2 into the first and second projection LCD lamps 120A and 120B.

The first LCD projection lamp 120A may generate first LCD source light corresponding to the first viewpoint image VI1 loaded from the host system 110 and may output the generated first LCD source light to the first LCD shutter 140A.

The second LCD projection lamp 120B may generate second LCD source light corresponding to the second viewpoint image VI2 loaded from the host system 110 and may output the generated second LCD source light to the second LCD shutter 140B.

The synchronization unit 130 may control a shutter timing of each of the first and second LCD shutters 140A and 140B, for removing interference between the first and second multi-viewpoint images VI1 and VI2. That is, the synchronization unit 130 may control the shutter timing of each of the first and second LCD shutters 140A and 140B to control a synchronization timing between the first and second multi-viewpoint images VI1 and VI2.

As described above, the synchronization unit 130 according to an embodiment of the present invention may separately control the shutter timings of the first and second LCD shutters 140A and 140B so as to prevent interference from occurring between the adjacent first and second multi-viewpoint images VI1 and VI2.

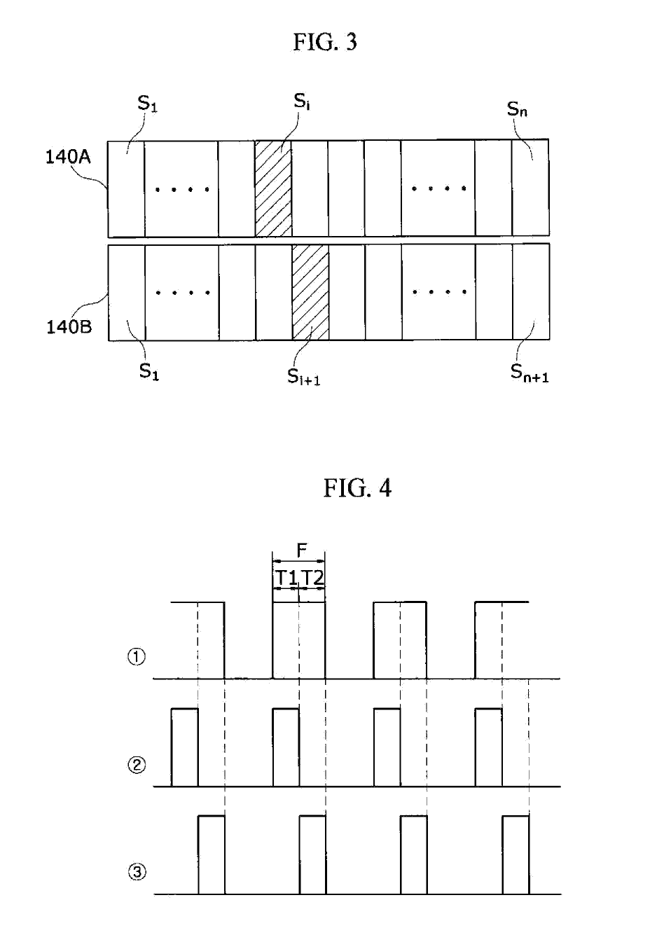

That is, the first LCD shutter 140A may output the first LCD source light to the first projection objective 150A according to a first shutter timing controlled by the synchronization unit 130, and the second LCD shutter 140B may output the second LCD source light to the second projection objective 150B according to a second shutter timing having a certain time difference with the first shutter timing controlled by the synchronization unit 130. The shutter timings of the first and second LCD shutters 140A and 140B will be described below in detail with reference to FIGS. 3 to 5.

The first projection objective 150A may convert the first LCD source light corresponding to a first viewpoint, which is output from the first LCD shutter 140A, into first image light corresponding to the first viewpoint and including image information according to the first shutter timing of the first LCD shutter 140A.

The second projection objective 150B may convert the second LCD source light corresponding to a second viewpoint, which is output from the second LCD shutter 140B, into second image light corresponding to the second viewpoint and including the image information according to the second shutter timing of the second LCD shutter 140B. The image information included in the first image light and the image information included in the second image light may each include red (R), green (G), and blue (B) color information.

The image light combination unit 160 may combine the first image light corresponding to the first viewpoint, which is output from the first projection objective 150A, with the second image light corresponding to the second viewpoint which is output from the second projection objective 150B. The image light combination unit 160 may be implemented with a half mirror or a beam splitter, for combining the first image light with the second image light.

Light generated through combination by the image light combination unit 160 may be projected onto a projection screen 300, and the light projected onto the projection screen 300 may be provided to one eye of a viewer, thereby enabling the viewer to view a super multi-viewpoint image.

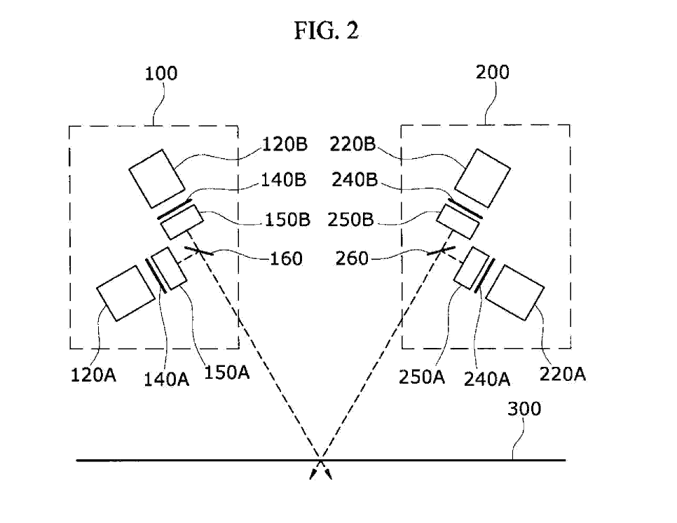

FIG. 2 is a diagram illustrating a configuration of a super multi-viewpoint image generating device according to another embodiment of the present invention.

Referring to FIG. 2, the super multi-viewpoint image generating device according to another embodiment of the present invention, may generate a super multi-viewpoint image which is provided to two eyes of a viewer in a glasses-free type. The super multi-viewpoint image generating device 100 illustrated in FIG. 1 may be symmetrically configured for providing the super multi-viewpoint image to the two eyes of the viewer.

In detail, the super multi-viewpoint image generating device according to another embodiment of the present invention may include a left-eye super multi-viewpoint image generating device 100 and a right-eye super multi-viewpoint image generating device 200.

The left-eye super multi-viewpoint image generating device 100 illustrated in FIG. 2 is the same as the super multi-viewpoint image generating device 100 illustrated in FIG. 1. The description made with reference to FIG. 1 may be applied to the left-eye super multi-viewpoint image generating device 100.

In order for the right-eye super multi-viewpoint image generating device 200 illustrated in FIG. 2 to be configured symmetrical with the left-eye super multi-viewpoint image generating device 100, the right-eye super multi-viewpoint image generating device 200 may include first and second LCD projection lamps 220A and 220B, first and second LC shutters 240A and 240B, first and second projection objectives 250A and 250B, and a half mirror 260.

The elements may perform the same functions as those of the elements 120A, 120B, 140A, 140B, 150A, 150B and 160 of the super multi-viewpoint image generating device 100. The descriptions made with reference to FIG. 1 may be applied to the elements 220A, 220B, 240A, 240B, 250A, 250B and 260. In FIG. 2, for conciseness of the drawing, the host system 110, the storage unit 120, and the synchronization unit 130 illustrated in FIG. 1 are not illustrated.

As described above, in the super multi-viewpoint image generating device according to another embodiment of the present invention, the super multi-viewpoint image generating device 100 illustrated in FIG. 1 may be configured in a symmetrical structure, and thus, a whole system may be compactly designed.

FIGS. 3 to 5 are diagrams for describing operations of the first and second LCD shutters illustrated in FIG. 1.

The first and second LCD shutters 140A and 140B may each include n number of stripe shutters S₁ to Sₙ (where n is a natural number) which are arranged in a horizontal direction.

The n stripe shutters S₁ to Sₙ may be controlled to be sequentially turned on in a direction from the left to the right or from the right to the left according to timing control by the synchronization unit 130.

In detail, positions of the stripe shutters S₁ to Sₙ turned on in the first LCD shutter 140A and positions of the stripe shutters S₁ to Sₙ turned on in the second LCD shutter 140B may be differently controlled.

For example, when an, ith stripe shutter Sᵢ (where i is a natural number less than n) of the n stripe shutters S₁ to Sₙ of the first LCD shutter 140A is turned on, an i+1st stripe shutter Sᵢ₊ᵢ of the n stripe shutters S₁ to Sₙ of the second LCD shutter 140B may be controlled to be turned on. That is, the ith stripe shutter Sᵢ of the first LCD shutter 140A and the i+1st stripe shutter Sᵢ₊₁ of the second LCD shutter 140B may be controlled to be alternately turned, on.

Moreover, a turn-on section of the ith stripe shutter Sᵢ of the first LCD shutter 140A and a turn-on section of the i+1st stripe shutter Sᵢ₊₁ of the second LCD shutter 140B may be controlled to be different from or identical to each other on a time axis.

For example, as shown in FIG. 4, when one frame F is defined as a first time section T1 and a second time section T2 successive to the first time section T1 in time on the time axis, the ith stripe shutter Sᵢ may be controlled to be turned on during the first time section T1, and the i+1st stripe shutter Sᵢ₊₁ may be controlled to be turned on during the second time section T2. Here, for example, the first time section T1 and the second time section T2 may each have the same duration, but are not limited thereto. \textcircled{1} is a output timing of super multi-view image, \textcircled{2} is a shutter timing of the first LCD shutters 140A, and \textcircled{3} is a shutter timing of the second LCD shutters 140B,

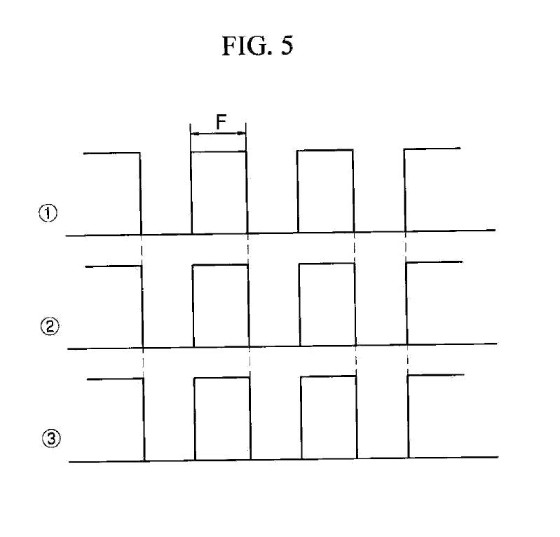

In other embodiments, as shown in FIG. 5, the ith stripe shutter Sᵢ of the first LCD shutter 140A and the i+1st stripe shutter Sᵢ₊₁ of the second LCD shutter 140B may be controlled to be simultaneously turned on during one frame.

Moreover, a turn-on time of each of the n stripe shutters S₁ to Sₙ may be controlled to 1/16 of a time corresponding to one frame.

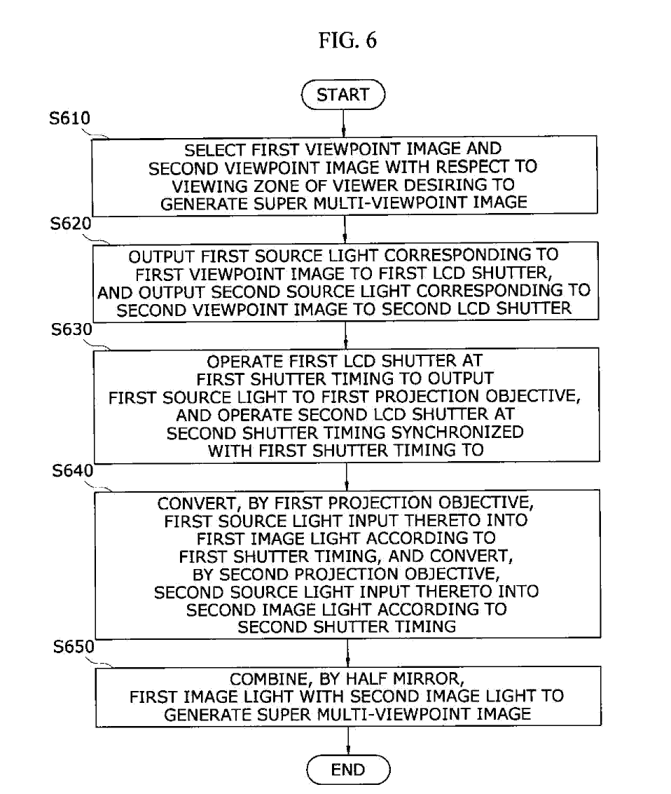

FIG. 6 is a flowchart illustrating a super multi-viewpoint image generating method according to an embodiment of the present invention. To help understand description, FIG. 1 will be referred to together.

Referring to FIG. 6, first, in step S610, a first viewpoint image and a second viewpoint image may be selected with respect to a viewing zone of a viewer desiring to generate a super multi-viewpoint image.

Subsequently, in step S620, the first LCD projection lamp 120A may generate first source light corresponding to the first viewpoint image to output the first source light to the first LCD shutter 140A, and the second LCD projection lamp 120B may generate second source light corresponding to the second viewpoint image to output the second source light to the second LCD shutter 140B.

Subsequently, in step S630, the first LCD shutter 140A may operate at a first shutter timing to output the first source light to the first projection objective 150A, and the second LCD shutter 140B may operate at a second shutter timing synchronized with the first shutter timing to output the second source light to the second projection objective 150B.

In detail, the stripe shutters S₁ to Sₙ of the first LCD shutter 140A may operate at the first shutter timing to be sequentially turned on in a direction from the left to the right or from the right to the left, and the stripe shutters S₁ to Sₙ of the second LCD shutter 140B may operate at the second shutter timing to be sequentially turned on in a direction from the left to the right or from the right to the left with a certain time difference with a time when one stripe shutter of the first LCD shutter 140A is turned on.

Subsequently, in step S640, the first projection objective 150A may convert the first source light input thereto into first image light according to the first shutter timing and the second projection objective 150B may convert the second source light input thereto into second image light according to the second shutter timing.

Subsequently, in step S650, the image light combination unit 160 may combine the first image light with the second image light to generate a super multi-viewpoint image.

Subsequently, the generated super multi-viewpoint image may be projected onto the projection screen to be provided to the viewer. If there is a next viewing zone of the viewer desiring to generate a super multi-viewpoint image, a first viewpoint image and a second viewpoint image may be selected with respect to the next viewing zone, and steps S610 to S650 may be again performed.

However, if there is, no next viewing zone of the viewer, a series of all operations of generating the super multi-viewpoint image may be ended.

The above-describe steps are relevant to a monocular super multi-viewpoint image generating method. When the steps are applied to a binocular super multi-viewpoint image generating method, steps S610 to S650 may be sequentially performed as a left-eye super multi-viewpoint image generating method, and simultaneously, may be sequentially performed as a right-eye super multi-viewpoint image generating method. A left-eye super multi-viewpoint image and a right-eye super multi-viewpoint image respectively generated by the methods may be projected onto the projection screen, and thus, the viewer may view a binocular super multi viewpoint image through the projection screen.

As described above, according to the embodiments of the present invention, a super multi-viewpoint image where interference between adjacent viewpoint images is removed by a viewing zone-based synchronized shutter timing may be generated, thereby providing an environment for generating a super multi-viewpoint image having a realistic level, establishing a method of generating a viewing zone-based super multi-viewpoint image, and displaying a super multi-viewpoint image.

Moreover, according to the embodiments of the present invention, a market size of 3D stereoscopic image content that does not provide visual fatigue caused by a mismatch between a binocular disparity and an eye adjustment action is considerably expanded, and realistic-level stereoscopic image content having a continuous disparity is actively manufactured. Accordingly, in comparison with the size of the existing image market, the present invention provides a turning point for causing a new revolution of the image market, and the derivatives market is considerably expanded.

Moreover, according to the embodiments of the present invention, the market for acquiring and creating super multi-viewpoint image content is activated, and an environment for the display verification of a super multi-viewpoint image is provided. Therefore, it is expected that industries associated with creation of super multi-viewpoint image content are additionally expanded. Also, since a more effective new device for generating a super multi-viewpoint image is provided, super multi-viewpoint image display technology is more upgraded, and thus, the mass production and consumption of super multi-viewpoint image content are greatly expanded.

Moreover, according to the embodiments of the present invention, since a device for generating a left-eye super multi-viewpoint image and a device for generating a right-eye super multi-viewpoint image are implemented in a symmetrical structure, a super multi-viewpoint image generating device having a compact size is manufactured and commercialized.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A super multi-viewpoint image generating device comprising:
a first shutter configured to receive a first viewpoint image to output first source light corresponding to the first viewpoint image according to a first shutter timing;
a second shutter configured to receive a second viewpoint image adjacent to the first viewpoint image to output second source light corresponding to the second viewpoint image according to a second shutter timing which differs from the first shutter timing;
a first projection objective configured to convert the first source light, output from the first shutter, into first image light according to the first shutter timing;
a second projection objective configured to convert the second source light, output from the second shutter, into second image light according to the second shutter timing; and
an image light combination unit configured to combine the first image light, output from the first projection objective, with the second image light output from the second projection objective to generate a super multi-viewpoint image.

2. The super multi-viewpoint image generating device of claim 1, wherein each of the first and second shutters comprises n (where n is a natural number) number of stripe shutters arranged in a horizontal direction.

3. The super multi-viewpoint image generating device of claim 2, wherein an ith (where i is a natural number less than n) stripe shutter of the first shutter and an i+1st stripe shutter of the second shutter are alternately turned on.

4. The super multi-viewpoint image generating device of claim 3, wherein when one frame is defined as a first time section and a second time section successive thereto in time, the ith stripe shutter is turned on during the first time section, and the i+1st stripe shutter is turned on during the second time section.

5. The super multi-viewpoint image generating device of claim 4, wherein each of the first and second time sections corresponds to ½ of a time corresponding to the one frame.

6. The super multi-viewpoint image generating device of claim 2, wherein an ith (where i is a natural number less than n) stripe shutter of the first shutter and an i+1st stripe shutter of the second shutter are simultaneously turned on during one frame.

7. The super multi-viewpoint image generating device of claim 1, further comprising a synchronization unit configured to control a shutter timing of the first shutter and a shutter timing of the second shutter.

8. A super multi-viewpoint image generating method comprising:
selecting a first viewpoint image and a second viewpoint image with respect to a viewing zone of a viewer;
generating first source light corresponding to the first viewpoint image and second source light corresponding to the second viewpoint image to respectively output the first source light and the second source light to a first shutter and a second shutter;
outputting, by the first shutter, the first source light to a first projection objective according to a first shutter timing and outputting, by the second shutter, the second source light to a second projection objective according to a second shutter timing;
converting, by the first projection objective, the first source light into first image light including image information and converting, by the second projection objective, the second source light into second image light including the image information; and
combining, by an image light combination unit, the first image light with the second image light to generate a super multi-viewpoint image.

9. The super multi-viewpoint image generating method of claim 8, wherein:
each of the first and second shutters comprises n (where n is a natural number) number of stripe shutters arranged in a horizontal direction, and
the outputting of the first source light and the second source light comprises alternately turning on an ith (where i is a natural number less than n) stripe shutter of the first shutter and an i+1st stripe shutter of the second shutter according to the first and second shutter timings to respectively output the first source light and the second source light to the first projection objective and the second projection objective.

10. The super multi-viewpoint image generating method of claim 9, wherein when one frame is defined as a first time section and a second time section successive thereto in time, the ith stripe shutter is turned on during the first time section, and the i+1st stripe shutter is turned on during the second time section.

11. The super multi-viewpoint image generating method of claim 10, wherein each of the first and second time sections corresponds to ½ of a time corresponding to the one frame.

12. The super multi-viewpoint image generating method of claim 8, wherein each of the first and second shutters comprises n (where n is a natural number) number of stripe shutters arranged in a horizontal direction, and
the outputting of the first source light and the second source light comprises simultaneously turning on the ith stripe shutter and the i+1st stripe shutter during one frame to respectively output the first source light and the second source light to the first projection objective and the second projection objective.

13. The super multi-viewpoint image generating method of claim 8, further comprising controlling, by a synchronization unit, the first shutter to the first shutter timing and controlling the second shutter to the second shutter timing.
